(19) United States
(12) Patent Application Publication
(10) Pub. No.: US 2008/0053536 A1
(43) Pub. Date: Mar. 6, 2008

(54) High flow insert type check valve

(75) Inventors: Stuart K. Denike, Phoenix, AZ (US); Don J. Atkins, Chandler, AZ (US); Robert D. Sleeper, Laveen, AZ (US); Joseph J. Jira, Laveen, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/514,749

(22) Filed: Aug. 31, 2006

(51) Int. Cl. F16K 15/03

(52) U.S. Cl. 137/512.1

(57) ABSTRACT

A check valve is provided for use in a low pressure differential system. The check valve includes a valve body, a support bar, stop supports, a shaft, a stop mechanism, and flappers. The valve body has a first and a second flow channel extending therethrough that each has an inlet and a corresponding outlet. The inlets have a cross sectional flow area that is greater than a cross sectional flow area of the corresponding outlet. The support bar extends radially across and axially along the valve body to separate flow channels and has a tapered upstream edge extending along a radial length thereof. The shaft is coupled to and extends between stop supports. The stop mechanism is coupled to and extends between the stop supports downstream from the shaft. Flappers are rotationally mounted to the valve body, moveable between a closed position and an open position.

### TECHNICAL FIELD

The present invention relates to check valves and, more particularly, to high flow, low pressure loss check valves for pneumatic systems.

### BACKGROUND

Insert style check valves are used to control air flow in a pneumatic system and may be installed for the purpose of reducing system weight and costs. For example, the check valves may be used to replace larger, body style check valves that are in ducts of the pneumatic system. Generally, check valves operate by moving between a closed position, where the valve seals the duct and prevents air from flowing in a reverse direction, and an open position, where the valve unseals the duct and allows air flow in a forward direction.

One exemplary type of insert style check valve is a split flapper check valve, such as the one shown in FIGS. 1-3. A split flapper check valve 10 typically includes a valve body 12, a shaft 14, a pair of flappers 16, 18, and a stop tube 20. The valve body 12 is configured to be inserted into a particular duct within the pneumatic system and includes an upstream face 34, a downstream face 36, and a pair of flow channels 28, 30 therebetween. A support bar 22 extends across the valve body 12 separating the two flow channels 28, 30 and has a flat face 32 that is formed substantially flush with the upstream face 34 of the valve body 12. Consequently, the flow channels 28, 30 typically have a total inlet cross sectional flow area that makes up about 60% to 65% of the area of the upstream face 34.

A pair of stop supports 24, 26 also extends axially from the valve body 12. The shaft 14 and stop tube 20 are coupled to and extend between the stop supports 24, 26. The flappers 16, 18 are rotationally mounted to the shaft 14 and configured to open the valve 110. When in the open position, the flappers 16, 18 are prevented from contacting each other by the stop tube 20. In most cases, the stop tube 20 is located a sufficient distance away from the valve body 12 to allow the flappers 16, 18 to open to a fully open position. Accordingly, the stop supports 24, 26 are relatively long, having an axial length that is a substantial percentage of the radius of the valve body 12, such as greater than about 50%.

The aforementioned split flapper check valves have been useful for controlling flow between environments having relatively large pressure differentials (e.g. 25 psi or greater) therebetween. However, it has been found that these check valves do not operate as efficiently as desired in lower pressure differential systems, such as environmental control systems. Specifically, the inlet cross sectional flow area of current split flapper check valves may not be sufficiently configured to respond to low pressure differentials. Thus, the check valves may not operate in certain low pressure differential environments. Moreover, because current split flapper check valves include bulky components, such as elongated stop supports and a relatively thick support bar, they may not be useful in certain thin-walled ducts.

Accordingly, there is a need for a split flapper check valve that is sensitive to pressure differentials that may be 1 psi or less. In addition, there is a need for split flapper check valve that is lightweight and relatively inexpensive to implement. Furthermore, other desirable features and characteristics of the present invention will become apparent from the subsequent detailed description and the appended claims, taken in conjunction with the accompanying drawings and the foregoing technical field and background

### BRIEF SUMMARY

The present invention provides a check valve for use in a low pressure differential system. In one embodiment, and by way of example only, the check valve includes a valve body, a support bar, a first and a second stop support, a shaft, a stop mechanism, and a first and a second flapper. The valve body has a first and a second flow channel extending therethrough, where each flow channel has an inlet and a corresponding outlet, the inlets each having a cross sectional flow area that is greater than a cross sectional flow area of the corresponding outlet. The support bar extends radially across and axially along the valve body to separate the first and the second flow channels. The support bar has a radial length and a tapered upstream edge formed thereon. The first and second stop supports extend axially from the valve body. The shaft is coupled to and extends between the first and the second stop supports. The stop mechanism is coupled to and extends between the first and the second stop supports downstream from the shaft. The first and second flappers are rotationally mounted to the valve body, and each of the flappers is moveable between a closed position, in which the flappers at least substantially seal the flow channels, and an open position, in which the flappers unseals the flow channels.

In another embodiment, by way of example only, the valve body has a first and a second flow channel extending therethrough, where each flow channel has an inlet and a corresponding outlet, the inlets each having a cross sectional flow area that is greater than a cross sectional flow area of the corresponding outlet. The support bar extends radially across and axially along the valve body to separate the first and the second flow channels. The support bar has a radial length and a tapered upstream edge formed thereon. The first and second stop supports extend axially from the valve body. The shaft is coupled to and extends between the first and the second stop supports. The stop mechanism is coupled to and extends between the first and the second stop supports downstream from the shaft. The first and second flappers are rotationally mounted to the shaft. Each of the flappers includes a lug formed thereon, and each lug has a mount hole through which the shaft extends. The first and second flappers are configured to move between a closed position, to thereby at least partially seal the flow channel, and an open position, to thereby unseal the flow channel and cause contact between the lug and the stop mechanism when a differential pressure across the seal is greater than a predetermined value.

In still another embodiment, by way of example only, the valve body has a first and a second flow channel extending therethrough, where each flow channel has an inlet and a corresponding outlet, the inlets each having a cross sectional flow area that is greater than a cross sectional flow area of the corresponding outlet. The support bar extends radially across and axially along the valve body to separate the first and the second flow channels. The support bar has a radial length and a tapered upstream edge formed thereon. The first and second stop supports extend axially from the valve body. The shaft is coupled to and extends between the first and the second stop supports. The stop mechanism is coupled to and extends between the first and the second stop supports downstream from the shaft. The first and second flappers are rotationally mounted to the shaft, and each of the flappers includes a boss extended therefrom. The first and second flappers are configured to move between a closed position, to thereby at least partially seal the flow channel, and an open position, to thereby unseal the flow channel and cause contact between the boss and the stop mechanism when a differential pressure across the seal is greater than a predetermined value.

Other independent features and advantages of the preferred check valve will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a prior art split flapper check valve;

FIG. 2 is a forward view of the prior art split flapper check valve shown in FIG. 2;

FIG. 3 is a side view of the prior art split flapper check valve shown in FIG. 1;

FIG. 4 is a simplified schematic diagram illustrating an air distribution system; and

FIG. 5 is a perspective view of an exemplary split flapper check valve that may be employed into the air distribution system shown in FIG. 4;

FIG. 6 is an aft view of the split flapper check valve shown in FIG. 5;

FIG. 7 is a side view of the split flapper check valve shown in FIG. 5;

FIG. 8 is a forward view of the split flapper check valve shown in FIG. 5; and

FIG. 9 is a side view of another exemplary split flapper check valve that may be employed into the air distribution system shown in FIG. 4.

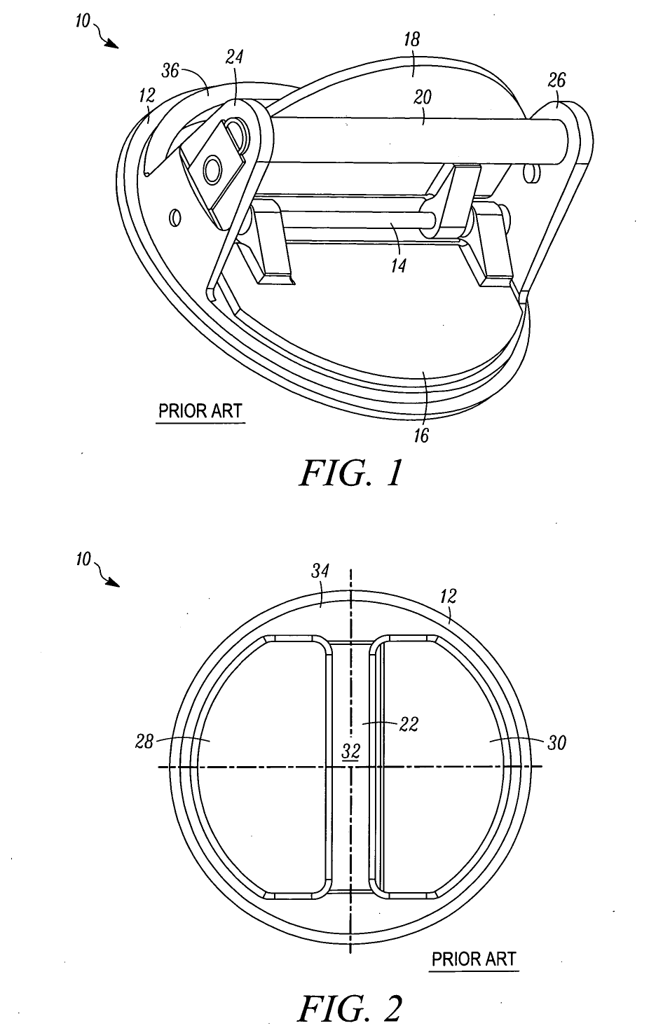

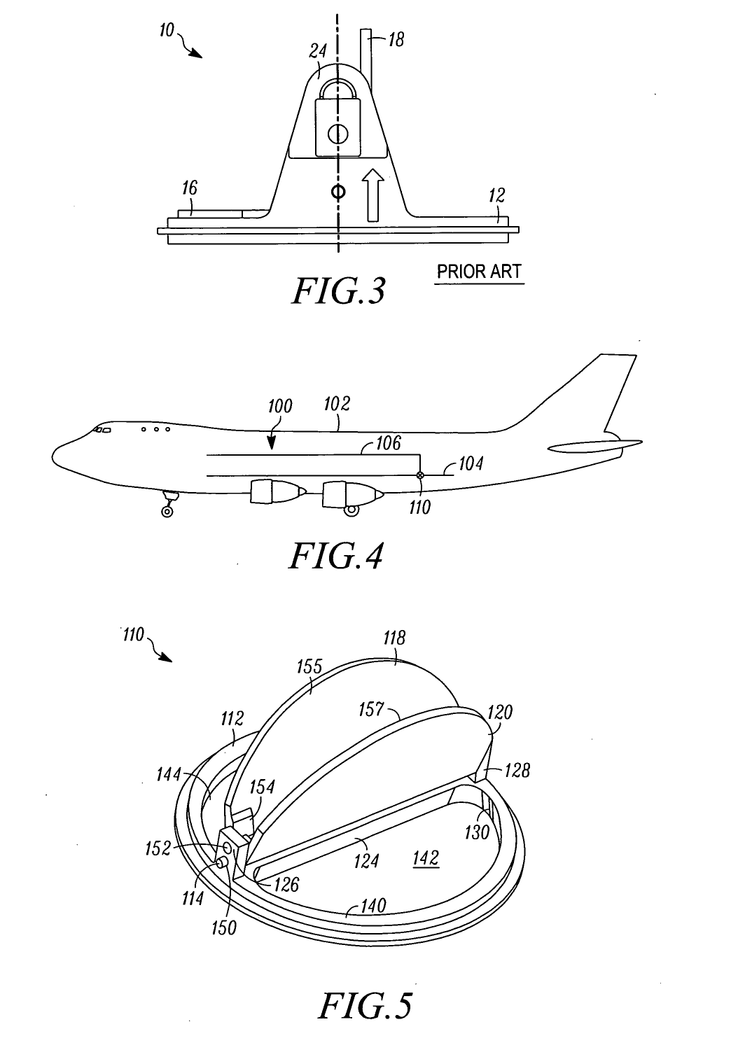

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

FIG. 4 is a simplified schematic diagram illustrating an air distribution system 100 disposed within an aircraft 102. The air distribution system 100 includes an inlet duct 104, one or more outlet ducts 106 (only one of which is shown here), and a valve 110 positioned in the duct 106. The inlet duct 104 receives air from an air source, such as, for example, engine bleed air, and the outlet duct 106 exhausts air into desired sections of the aircraft 102. In one exemplary embodiment, the outlet duct 106 exhausts air into an aircraft cabin (not shown). The valve 110 is configured to control the air flow through the outlet duct 106 and to prevent the air from flowing in a reverse direction.

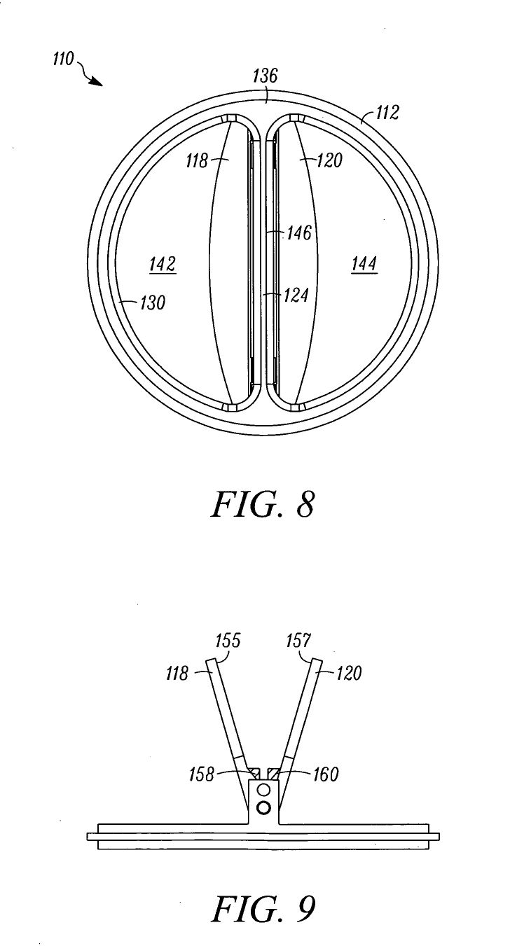

FIGS. 5-8 show several perspective views of an exemplary physical implementation of the valve 110. The valve 110 includes a valve body 112, a shaft 114, a stop mechanism 116, and two flappers 118, 120. The valve body 112 is configured to be coupled to and disposed at least partially within the duct 106 (shown in FIG. 4), and includes a support bar 124 and two stop supports 126, 128. The valve body 112 has an upstream face 136, a downstream face 140, and an inner surface 130 that at least partially defines a pair of flow channels 142, 144. The inner surface 130 is preferably tapered such that an inlet cross sectional flow area of the flow channels 142, 144 is greater than downstream cross sectional flow areas of the flow channels 142, 144.

The support bar 124 extends radially across and axially along the valve body 112 separating the flow channels 142, 144. Preferably, the support bar 124 and valve body 112 are configured to maximize the inlet cross sectional flow area relative to the upstream face 136. In one embodiment, the inlet cross sectional flow area comprises at least 75% of the area of the valve body upstream face 136. Maximization of the inlet cross sectional flow area allows the valve 110 to respond to pressure changes that are less than about 1 psi. In one embodiment, the inlet cross sectional flow area is further maximized by including a tapered upstream edge 146 along a radial length of the support bar 124. The upstream edge 146 may be v-shaped or beveled. Additionally, the upstream edge 146 may or may not be substantially flush with the valve body upstream face 136.

The valve body 112 also includes a valve seat 148 located on its downstream face 140. As will be discussed later, the valve seat 148 is configured to provide a surface with which the flappers 118, 120 selectively contact to seal and unseal the valve 110. The two stop supports 126, 128 extend axially from the valve body 112 and are generally spaced equally apart from one another. Preferably, the stop supports 126, 128 each have an axial length that is less than about 50% of the radius of the valve body 112. The stop supports 126, 128 include two pairs of mount holes 150, 152 for mounting the shaft 114 and stop mechanism 116, respectively.

As alluded to above, the flappers 118, 120 are rotationally mounted to the valve body 112, preferably via the shaft 114 and selectively seal and unseal the flow channels 142, 144. Preferably, the flappers 118, 120 are configured such that a minimal amount of air leaks across the valve 110 when the flow channels 142, 144 are sealed. In this regard, the magnitude of force that is needed to cause the flappers 118, 120 to seal the valve seat 148 is preferably minimized. In one embodiment, contact pressure between the flappers 118, 120 and valve seat 148 is increased by minimizing contact area therebetween. For example, the flappers 118, 120 and valve seat 148 may be configured such that the contact area between the flapper 118, 120 and valve body 112 is reduced by 50% as compared to prior art configurations, thereby doubling the contact pressure and improving valve sealing.

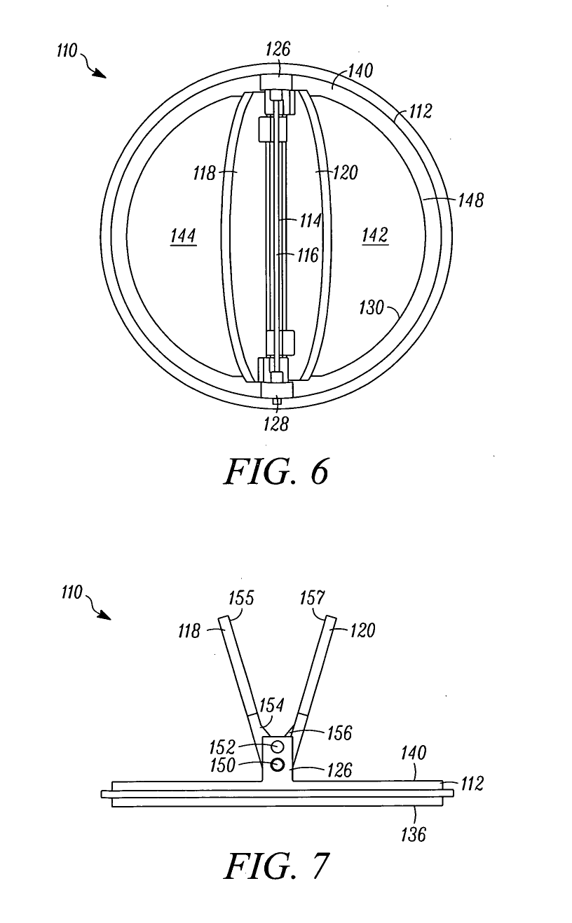

Each flapper 118, 120 preferably includes one or more protrusions that extend from downstream faces 155, 157 thereof and that are configured to contact the stop mechanism 116. In one exemplary embodiment depicted in FIG. 6, the protrusions are lugs 154, 156 formed on the flappers 118, 120. The lugs 154, 156 include mount holes (not shown) that correspond to and align with the stop support mount holes 150 and allow the shaft 114 to extend therethrough. In another exemplary embodiment shown in FIG. 9, each flapper 118, 120 includes one or more bosses 158, 160 that protrude therefrom. The flappers 118, 120 may also include lugs 154, 156.

In some embodiments, the flappers 118, 120 may be biased toward the closed position and may each be coupled to one or more torsion springs (not shown). The torsion springs supply a predetermined torsional force that urges the flappers 118, 120 toward the closed position to thereby seal the flow channels 142, 144. When the differential pressure magnitude exceeds a predetermined value and overcomes the torsional force, the flappers 118, 120 move to an open position to unseal the flow channels 142, 144. Preferably, the predetermined value is a pressure that can be withstood by the inlet duct 104 and the outlet duct 106 without compromising their structural integrity and that can be detected by the valve 110.

A split flapper check valve has now been provided that can detect pressure differentials that may be lower than about 1 psi. In addition, the split flapper check valve is lightweight and relatively inexpensive to implement. Moreover, the valve is easily implemented into existing systems.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A check valve for disposal in a duct, the check valve comprising:
a valve body having a first and a second flow channel extending therethrough, each flow channel having an inlet and a corresponding outlet, the inlets each having a cross sectional flow area that is greater than a cross sectional flow area of the corresponding outlet;
a support bar extending radially across and axially along the valve body to separate the first and the second flow channels, the support bar having a radial length and a tapered upstream edge formed thereon;
a first and a second stop support extending axially from the valve body;
a shaft coupled to and extending between the first and the second stop supports;
a stop mechanism coupled to and extending between the first and the second stop supports downstream from the shaft; and
a first and a second flapper rotationally mounted to the valve body, each of the flappers moveable between a closed position, in which the flappers at least substantially seal the flow channels, and an open position, in which the flappers unseal the flow channels.

2. The check valve of claim 1, wherein the stop mechanism comprises a spring grade material.

3. The check valve of claim 1, wherein the valve body has a tapered inner surface and the first and second flow channels are at least partially defined by the tapered inner surface.

4. The check valve of claim 1, wherein the first and the second flappers each include a lug formed thereon, each lug having a mount hole through which the shaft extends, the lugs configured to contact the stop mechanism when the differential pressure across the seal is greater than a predetermined value.

5. The check valve of claim 1, wherein the first and the second flappers each include a boss extended therefrom, each boss configured to contact the stop mechanism when the differential pressure across the seal is greater than a predetermined value.

6. The check valve of claim 5, wherein the first and the second flappers each include a lug formed thereon, each lug having a mount hole through which the shaft extends.

7. The check valve of claim 1, wherein the valve body has an upstream face having an area, and the inlet cross sectional flow area comprises at least about 75% of the upstream face area.

8. The check valve of claim 1, wherein:
the valve body has an upstream side having a radius; and
the first and second stop supports each has an axial length that is less than about 50% of the valve body upstream side radius.

9. The check valve of claim 1, wherein the tapered upstream edge is beveled.

10. The check valve of claim 1, wherein the tapered upstream edge is v-shaped.

11. A check valve for disposal in a duct, the check valve comprising:
a valve body having a first and a second flow channel extending therethrough, each flow channel having an inlet and a corresponding outlet, the inlets each having a cross sectional flow area that is greater than a cross sectional flow area of the corresponding outlet;
a support bar extending radially across and axially along the valve body to separate the first and the second flow channels, the support bar having a tapered upstream edge extending along a radial length thereof;
a first and a second stop support extending axially from the valve body;
a shaft coupled to and extending between the first and the second stop supports;
a stop mechanism coupled to and extending between the first and the second stop supports downstream from the shaft; and
a first and a second flapper rotationally mounted to the shaft, each of the flappers including a lug formed thereon, each lug having a mount hole through which the shaft extends, the first and second flappers configured to move between a closed position, to thereby at least partially seal the flow channel, and an open position, to thereby unseal the flow channel and cause contact between the lug and the stop mechanism when a differential pressure across the seal is greater than a predetermined value.

12. The check valve of claim 1 1, wherein the valve body has a tapered inner surface and the first and second flow channels are at least partially defined by the tapered inner surface.

13. The check valve of claim 1 1, wherein the stop mechanism comprises a spring grade material.

14. The check valve of claim 1 1, wherein the valve body has an upstream face having an area, and the inlet cross sectional flow area comprises at least about 75% of the upstream face area.

15. The check valve of claim 1 1, wherein the valve body has an upstream side having a radius and the first and second stop supports each having an axial length that is less than 50% of the valve body upstream radius.

16. The check valve of claim 11, wherein the tapered upstream edge is beveled.

17. The check valve of claim 1 1, wherein the tapered upstream edge is v-shaped.

18. A check valve for disposal in a duct, the check valve comprising:
a valve body having a first and a second flow channel extending therethrough, each flow channel having an inlet and a corresponding outlet, the inlets each having a cross sectional flow area that is greater than a cross sectional flow area of the corresponding outlet;
a support bar extending radially across and axially along the valve body to separate the first and the second flow channels, the support bar having a tapered upstream edge extending along a radial length thereof;
a first and a second stop support extending axially from the valve body;
a shaft coupled to and extending between the first and the second stop supports;
a stop mechanism coupled to and extending between the first and the second stop supports downstream from the shaft; and
a first and a second flapper rotationally mounted to the shaft, each of the flappers including a boss extended therefrom, the first and second flappers configured to move between a closed position, to thereby at least partially seal the flow channel, and an open position, to thereby unseal the flow channel and cause contact between the boss and the stop mechanism when a differential pressure across the seal is greater than a predetermined value.

19. The check valve of claim 18, wherein the first and the second flappers each include a lug formed thereon, each lug having a mount hole through which the shaft extends.

20. The check valve of claim 18, wherein the valve body has an upstream face having an area, and the inlet cross sectional flow area comprises at least about 75% of the upstream face area.
